(19) United States
(12) Patent Application Publication
(10) Pub. No.: US 2003/0223163 A1
(43) Pub. Date: Dec. 4, 2003

(54) AC/DC secondary shock hazard protection circuit and device for welding power supplies

(76) Inventor: Dennis R. Robbins, Kent, WA (US)

Correspondence Address: Delbert J. Barnard, Barnard, Loop & McCormack LLP, P.O. Box 58888, Seattle, WA, 98138, US

(21) Appl. No.: 10/443,403

(22) Filed: May 22, 2003

Related U.S. Application Data
(60) Provisional application No. 60/385,235, filed on May 31, 2002.

(51) Int. Cl. H02H 3/00

(52) U.S. Cl. 361/42

(57) ABSTRACT

A control system is interposed between the input terminal (14) and the output terminal (16) of a welding machine (10). An electrical conductor (18) is connected to the input terminal. A ground conductor (20) extends out from the housing (12) of the welding machine (10). An electrode conductor (24) extends from the output terminal (16) to an electrode holding device (26). An electrode (28) is held by the electrode holder (26). The control circuit includes means for connecting welding voltage to the electrode holding device (26) and the electrode (28) when the electrode (28) is connected to a grounded workpiece (50). A control circuit also connects the electrode holding device (26) and the electrode (28) to a lower, safe voltage, when the electrode (28) is disconnected from the grounded workpiece (50). As a result, the welder is protected from electrical shocks when the electrode (28) is disconnected from the grounded workpiece (50). The control circuit is characterized by one, two, three or more SCRs.

### RELATED APPLICATIONS

This application claims the benefit of the filing date of Provisional Application No. 60/385,235, filed May 31, 2002, and entitled AC/DC Secondary Shock Hazard Protection Circuit and Device For Welding Power Supplies.

### TECHNICAL FIELD

This invention relates to welding machines. More particularly, it relates to welding machines adapted to automatically lower the voltage present at the output terminals to a safe level in response to the electrode being disconnected from the workpiece, and to automatically increase the voltage to a welding level in response to the electrode being connected to the workpiece.

### BACKGROUND OF THE INVENTION

Care must be exercised to prevent welding machine operators (herein “welders”) from being shocked by the secondary AC or DC output from the welding machine. This shock hazard problem is most prevalent with the stick metal arc welding (herein “SMAW”) process and machine. However, welders can be and are shocked with other welding processes and machines as well.

Conventional welding machines have an open circuit voltage present at the output terminals when the output power is on and the machine is in idle mode. This open circuit voltage can be as high as 100 volts AC or DC, or higher. The welding electrode, the lead, and the work ground and lead are connected to the output terminals and allow current from the welding machine to be utilized for welding processes known as SMAW, GMAW and GTAW welding. The welders must hold the welding electrode while welding. Conventional designs for welding machines for the SMAW, GMAW and GTAW processes have up to 100 volts AC or DC open circuit volts AC or DC present at the output terminal. The shocking problem occurs when the welder must weld under conditions in which the welders' hands and gloves get wet from rain or perspiration. Welders may also have holes in their gloves or their clothing. In many working environments, welding is inherently accompanied by metallic dust and grindings that are extremely electrically conductive. All of these factors contribute to the welder receiving an electric shock when they make contact with the electrode and work ground, completing an electrical circuit that creates an electrical shock hazard. It is recognized by many persons in the field, including OSHA personnel, that many falls taken by welders are caused by these shocks.

It is the object of the present invention to reduce the shock hazard by reducing the voltage present at the output terminals of the welding machine when the electrode is disconnected from the work piece. The voltage is lowered to a safe level (e.g. about 8.9 to about 30 volts AC or DC, depending on the welding power supply.

### BRIEF SUMMARY OF THE INVENTION

The primary object of the present invention is to provide a control system for an electric arc welder, for controlling the supply of electrical power to an electrode holder and an electrode, for protecting the welder from electrical shocks. A control circuit is provided between an input terminal and an output terminal. The control circuit includes means for automatically connecting welding voltage to the electrode holder and the electrode when the electrode is connected to a grounded workpiece. It also automatically connects the electrode holder and electrode to a lower, safe voltage when the electrode is disconnected from the grounded workpiece. As a result, the welder is protected from electrical shocks when the electrode is disconnected from the grounded workpiece.

In the preferred embodiments, the control circuit includes at least one SCR that is positioned between the input terminal and the electrode holder and the electrode.

The first embodiment of the invention includes a single SCR that operates at about 400 AMPs. A second embodiment includes two SCRs and it operates at 600-800 AMPs. A third embodiment includes three SCRs and it operates at 1200 AMPs. A fourth embodiment includes two SCRs in a triac configuration. This embodiment utilizes alternating current.

Other objects, advantages and features of the invention will become apparent from the description of the best mode and other embodiments set forth below, from the drawings, from the claims and from the principles that are embodied in the specific structures and circuits that are illustrated and described.

### BRIEF DESCRIPTION OF THE SEVERAL VIEWS OF THE DRAWING

Like reference numerals are used to designate like parts throughout the several views of the drawing, and:

FIG. 1 is a schematic diagram showing a welding machine housing including an input connection that is connected to an electrical source, an output connection, and an electrical conductor that extends from the output connector to a welding electrode;

FIG. 2 is an electrical schematic of a first circuit that includes a single SCR;

FIG. 3 is an electrical schematic of a circuit that includes two SCRs;

FIG. 4 is an electrical schematic of a circuit that includes three SCRs; and

FIG. 5 is an electrical schematic of an AC current circuit that includes two SCRs in a triac configuration.

### DETAILED DESCRIPTION OF THE INVENTION

FIG. 1 shows a welding machine 10 within a housing 12 that includes an input terminal 14 and an output terminal 16. An electrical conductor 18 extends from an electrical energy source to the input terminal 14. A second conductor 20 extends from a ground connection in the housing 12 to a connector or connection 22 that is secured to a workpiece. An electrical conductor 24 extends from output terminal 16 to an electrode holder 26 in which an electrode 28 is received. In known devices, the conductor 18 reading from the source of electrical energy is connected directly to the conductor 24 leading to the electrode holder 26 and electrode 28.

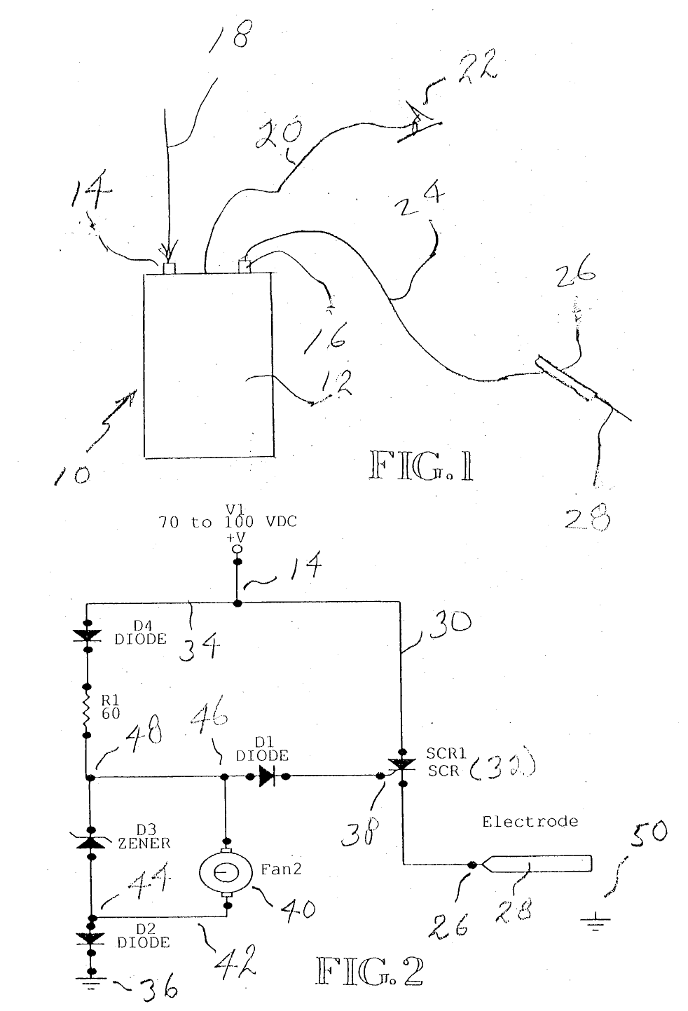

The welding machine 10 includes a control circuit within the housing 12 that functions to provide a voltage level at electrode holder 26 and electrode 28 that is at a welding level when the electrode 28 is in contact with the workpiece and is at a lower safe level when the electrode 28 is disconnected from the workpiece. FIGS. 2-5 show four different control circuits that are presented by way of example. FIG. 2 shows the input terminal 14 connected to a direct current voltage source of about 70 to about 100 Volts. A first branch conductor 30 extends from the input terminal 14 over to the electrode holder 26 and the electrode 28. This branch includes a SCR 1, designated 32. The second branch conductor 34 extends from the input terminal 14 to the SCR 32 via two diodes D4, D1 and a resistor R1. The resistor R1 limits current through diode 4 to 1200 mA. Two additional diodes D2, D3 prevent reverse voltage from entering the circuit from a ground 36. Diodes D2 and D4 are six AMP, 1000 PIV diodes. Zener diode D3 consists of multiple, parallel 13 Volt 5 Watt Zener diodes used to clamp the voltage at the SCR gate 38. A fan 40 is provided in a branch conductor 42 that extends from a juncture 44 to a juncture 46. Zener diode D3 is positioned between juncture 44 and juncture 48. It also clamps the voltage at the fans 40 to about 13 VDC. Diode D1 is a 3 AMP, 1000 PIV diode. It prevents reverse SCR gate current from flowing into the circuit. SCR 1 is preferably a 410 A, 800 V diode. In this embodiment, two fans 40 are used to circulate air across heat sinks, which are on the SCR 32.

During operation, before the welding electrode 28 is touched to a workpiece that is grounded, the anode of SCR 1 is at full open circuit potential. Zener diode D3 holds the SCR gate voltage at about 13 VDC. The cathode voltage of the SCR rises to the SCR gate potential of about 13 VDC. Since the electrode 28 is connected to the SCR cathode, the electrode voltage is also clamped at about 13 VDC. When the electrode 28 is touched to the grounded workpiece 50, the SCR cathode voltage drops to ground potential. When the cathode voltage decreases to about 5 VDC below the SCR gate voltage of about 13 VDC, the SCR 32 is triggered and permits electrical energy conduction from branch 30 to the electrode holder 26. Full welding voltage and current are then applied to the electrode 28. According to the invention, when the electrode 28 is lifted off from the grounded workpiece 50, the welding current ceases to flow through the circuit. The cathode voltage then rises to the about 13 VDC Zener voltage of D3 and is clamped at about 13 VDC.

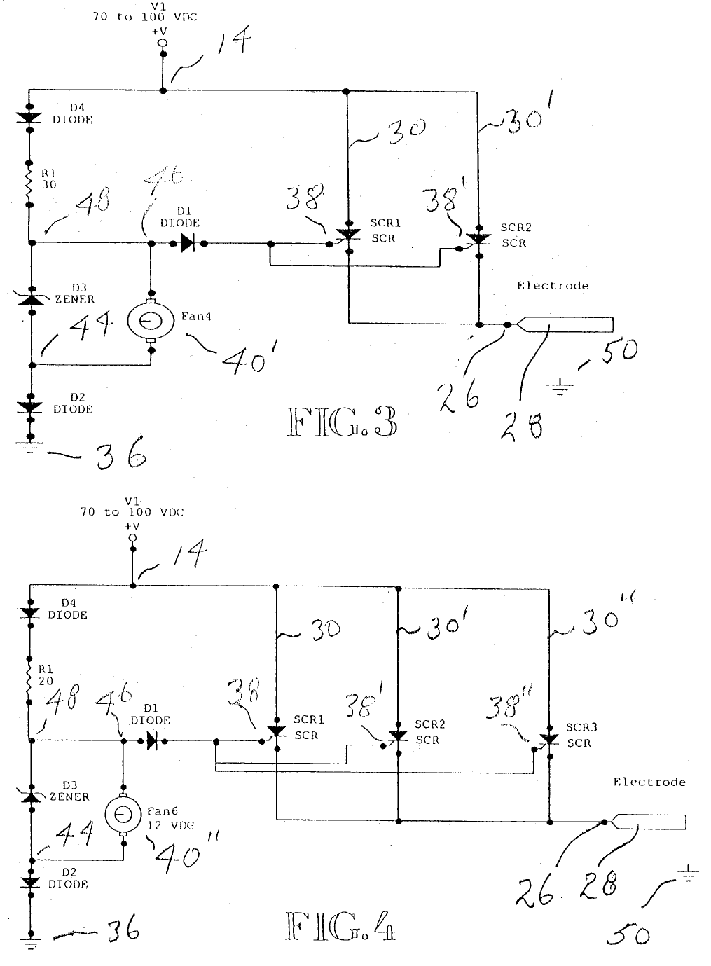

In FIG. 3, power for the control circuit is obtained from the welding unit. Resister R1 limits current through diode D4 to 2400 mA. Diodes D2 and D4 are 6 AMP, 1000 PIV diodes to prevent reverse voltages from entering the circuit. Zener Diode 53 consists of multiple parallel 13 Volt, 5 Watt Zener diodes used to clamp the voltage at the SCR gates and the arms 40′ to 13 VDC. Diode D1 is a 3 AMP, 1000 PIV diode to prevent reverse SCR gate current from flowing into the circuit. SCR 1 and SCR 2 are related 410 A and 800 V. In this embodiment, twelve VDC fans 40′ are used to circulate air across the heat sinks on SCR 1 and SCR 2.

During operation, before the welding electrode 28 is touched to the grounded workpiece 50, the anode SCR 1 and SCR 1 are at full open circuit potential. Zener diode D3 holds the SCR gate voltage at 13 VDC. The cathode voltage of the SCR s rises to the SCR gate potential of 13 VDC. Since the electrode 28 is connected to the SCR cathodes, the electrode voltage is also clamped at 13 VDC.

When the electrode 28 is touched to the grounded workpiece, the SCR cathode voltage drops to ground potential. When the cathode voltage decreases 5 VDC below the SCR gate voltage of 13 VDC, SCR 1 and SCR 2 are triggered into conduction. Full welding voltage and current is then applied to the electrode 28. When the electrode 28 is lifted from the grounded workpiece 50, welding current ceases. The cathode voltage then rises to the 13 VDC Zener voltage of D3 and is clamped at 13 VDC.

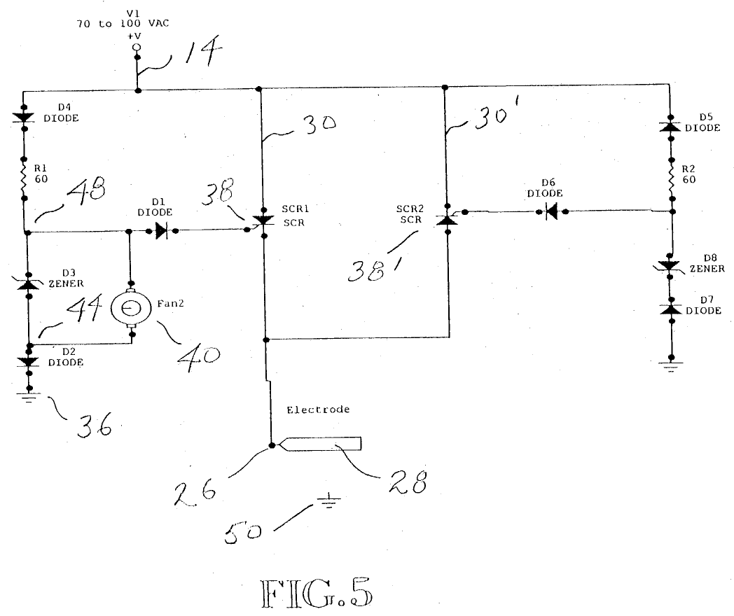

The circuit shown by FIG. 4 includes the components of the circuit shown by FIG. 3 and in addition includes a third SCR. Power for the circuit is obtained from the welding unit. Resister R1 limits current through diode D4 to 3700 mA. Diodes D2 and D4 are 6 AMP, 1000 PIV diodes. They prevent reverse voltages from entering the circuit. Zener diode D3 consists of multiple, parallel 13 Volt, 5 Watt Zener diodes. They serve to clamp the voltage at the SCR gates and the fans 40″ to 13 VDC. Diode D1 is a 3 AMP, 1000 PIV diode which functions to prevent reverse SCR gate current from flowing into the circuit. SCR 1, SCR 2 and SCR 3 are 410 A, 800 V. Twelve VDC fans are used to circulate air across the heat sinks on SCR 1, SCR 2 and SCR 3.

During operation, before the welding electrode 28 is touched to the grounded workpiece 50, the anodes of SCR 1, SCR 2 and SCR 3 are at full open circuit potential. Zener diode D3 holds the SCR gate voltage at 13 VDC. The cathode voltage of the SCRs rises to the SCR gate potential of 13 VDC. Since the electrode is connected to the SCR cathodes, the electrode voltage is also clamped at 13 VDC.

When the electrode 28 is touched to the grounded workpiece, the SCR cathode voltage drops to ground potential. When the cathode voltage decreases 5 VDC below the SCR gate voltage of 13 VDC, SCR 1, SCR 2 and SCR 3 are triggered into conduction. Full welding voltage and current has been applied to the electrode 28. When the electrode 28 is lifted from the grounded workpiece 50, welding current ceases. The cathode voltage then rises to the 13 VDC Zener voltage of D3 and is clamped at 13 VDC.

FIG. 5 shows another embodiment characterized by two SCRs in a triac configuration. During the positive half-cycle, diodes D5 and D7 block current to resistor R2, diode D8 and the gate of SCR 2. This prevents SCR 2 from conducting on the positive voltage cycle. During the negative half-cycle, diodes D2 and D4 block current to resistor R1, diode D3 and the gate of SCR 1. This prevents SCR 1 from conducting during the negative voltage cycle. During the positive half-cycle, resistor R1 limits the positive current through diode D4 to 1200 mA. Diodes D2 and D4 are 6 AMP, 1000 PIV diodes. They prevent negative voltages from entering the circuit. Zener diode D3 consists of multiple, parallel, 13 Volt, 5 Watt Zener diodes used to clamp the voltage at the SCR 1 gate 38 and the fan 40 to 13 Volts. Diode D1 is a 3 AMP, 1000 PIV diode. It prevents reverse gauge current of SCR 1 from flowing into the circuit. As the positive cycle voltage begins to rise from 0 VAC to the maximum welder open circuit voltage, Zener diode D3 voltage rises to a maximum of 13 Volts. This clamps the electrode voltage to a maximum of 13 Volts. When the voltage decreases from the positive half-cycle to 0, and beings the negative half-cycle, diodes D4 and D2 shut off and diodes D5 and D7 begin to conduct. During the negative half-cycle of the VAC current, the resister R2 limits current through diode D5 to 1200 mA. Diodes D5 and D7 are 6 AMP, 1000 PIV diodes. They prevent positive voltages from entering the circuit. Zener diode D8 consists of multiple, parallel, 13 Volt, 5 Watt Zener diodes that are used to clamp the voltage at the SCR 2 gate to 13 VDC. Diode D6 is a 3 AMP, 1000 PIV diode to prevent reverse gate current of SCR 2 from flowing into the circuit. As the negative voltage cycle decreases to −13 volts, Zener diode D8 clamps the voltage at the gate of SCR 2 to −13 volts. The electrode voltage is also clamped to −13 volts. SCR 1 and SCR 2 are 410 A, 800 V. Twelve VAC fans are used to circulate air across the heat sinks on SCR 1 and SCR 2.

During the positive half-cycle of operation, only diodes D1, D2, D3 and D4, and SCR 1, conduct current. When the electrode 28 is touched to the grounded workpiece 50, the cathode voltage of SCR 1 drops to ground potential. When the cathode voltage decreases 5 VDC below the SCR gate voltage of 13 VDC, SCR 1 is triggered into conduction. Full welding voltage and current is then applied to the electrode 28. Welding current continues to flow through SCR 1 until the A cycle brings the voltage back to 0. As the voltage crosses 0, SCR 1 stops conducting. As the voltage swings negatively, the diodes D5, D6, D7 and D8, and SCR 2, become conductive. When the SCR 2 gate voltage decreases to within 5 volts of the SCR 2 cathode, it begins to conduct. When this happens, full welding current is carried through SCR 2 on the negative voltage cycle. When the electrode 28 is lifted from the grounded workpiece 50, welding current decreases. The cathode voltage of the SCR 1 and SCR 2 rises to the 13 volt clamping value. During a complete cycle of the AC voltage swing, the electrode voltage is clamped to a maximum of 13 volts during the positive voltage cycle and is clamped to a maximum of −13 volts during the negative voltage cycle.

The illustrated embodiments are only examples of the present invention and, therefore, are non-limitive. It is to be understood that many changes in the particular structure, circuit details and features of the invention may be made without departing from the spirit and scope of the invention. For example, the various circuits that have been described may be provided with microprocessors programmed to perform the functions of the circuits that are illustrated and described. Therefore, it is my intention that my patent rights not be limited by-the particular embodiments illustrated and described herein, but rather my patent rights are to be determined by the following claims, interpreted according to accepted doctrines of patent claim interpretation, including use of the doctrine of equivalents and reversal of parts.

What is claimed is:

1. A control system for an electric arc welder, for controlling the supply of electrical power to an electrode holding device and electrode, for protecting the welder from electrical shocks, said system comprising:
an input terminal connected to a source of electrical power;
an output terminal connected to an electrode holding device in which an electrode is held; and
a control circuit connected between the input and output terminals, including means for automatically connecting welding voltage to the electrode holder and electrode when the electrode is connected to a grounded workpiece, and automatically connecting the electrode holding device and electrode to a lower, safe voltage when the electrode is disconnected from the grounded workpiece, whereby the welder is protected from electrical shocks when the electrode is disconnected from the grounded workpiece.

2. The control system of claim 1, wherein the control circuit includes at least one SCR is positioned between the input terminal and the electrode holding device and the electrode.

3. The control system of claim 1, comprising a single SCR positioned between the input terminal and the electrode holder and the electrode.

4. The control system of claim 2, comprising two SCRs between the input terminal and the electrode holder and the electrode.

5. The control system of claim 4, wherein the two SCRs are in a triac configuration.

6. The control system of claim 2, wherein the circuit includes three SCRs between the input terminal and the electrode holder and the electrode.

7. The control system of claim 1, wherein the circuit comprises diodes positioned to prevent reverse voltages from entering the circuit.

8. The control system of claim 7, comprising a SCR having a gate and a diode that holds the gate voltage at a predetermined voltage.

9. The control system of claim 1, wherein the circuit includes at least one SCR having a heat sink and at least one fan that circulates air across the heat sink.

10. The control system of claim 1, wherein the input terminal is connected to a source of direct current and the electrode is powered by the direct current.

11. The control system of claim 1, wherein the input terminal is connected to a source of alternating current and the electrode is powered by the alternating current.

12. The control system of claim 11, wherein at least one SCR is positioned between the input terminal and the electrode holder and the electrode.

13. The control system of claim 12, comprising two SCRs among the input terminal, the electrode holder and the electrode.

14. The control system of claim 13, wherein the two SCRs are in a triac configuration.
